(19) United States
(12) Patent Application Publication
(10) Pub. No.: US 2011/0031786 A1
(43) Pub. Date: Feb. 10, 2011

(54) CENTRIFUGAL AIR BLOWER AND AUTOMOBILE SEAT

(75) Inventors: Michihiro Kurokawa, Osaka (JP); Masao Kojima, Osaka (JP); Koji Kuyama, Hyogo (JP); Masahito Hidaka, Osaka (JP); Mineaki Isoda, Osaka (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Kadoma-shi, Osaka (JP)

(21) Appl. No.: 12/988,742

(22) PCT Filed: Mar. 9, 2010
(86) PCT No.: PCT/JP2010/001652

§ 371 Date: Oct. 20, 2010

(30) Foreign Application Priority Data
Apr. 3, 2009 (JP) 2009-091289

(51) Int. Cl. B60N 2/56; F04D 29/44

(52) U.S. Cl. 297/180.14; 415/212.1

(57) ABSTRACT

A centrifugal multi-blade impeller (10) that has a plurality of blades (11) around a central axis of rotation (10a) and that radially outwardly blows air taken in along the central axis of rotation is housed in a spiral scroll casing (20). The ratio of H/D of height H of the centrifugal multi-blade impeller in a direction of the central axis of rotation to diameter D of the centrifugal multi-blade impeller is 0.2 or less. The scroll casing has a logarithmic spiral spread angle γ of 2.0 degrees or more. It is thereby possible to provide a small and low profile centrifugal air blower that has high air blowing performance and is low noise.

### TECHNICAL FIELD

The present invention relates to a centrifugal air blower including a flat centrifugal multi-blade impeller having a ratio H/D of impeller height H to impeller diameter D of 0.2 or less. The present invention also relates to an automobile seat incorporating such a centrifugal air blower.

### BACKGROUND ART

Centrifugal air blowers have a configuration in which a centrifugal multi-blade impeller (hereinafter referred to as an “impeller”) is housed in a spiral scroll casing (hereinafter referred to as a “casing”). The impeller radially outwardly blows air that is taken in along the central axis of rotation. The casing converts the dynamic pressure to static pressure while collecting the air blown out of the impeller, and then blows the air from an outlet provided on a spiral end side of the casing.

Patent Document 1 discloses a centrifugal air blower of this type in which a low profile impeller having a ratio H/D (aspect ratio) of impeller height H in a direction of the central axis of rotation to impeller diameter D of 0.5 or less is used, and the minimum spacing (nose gap) between a nose (also referred to as a “tongue”) of the casing and the impeller is 0.08 times or more and 0.2 times or less the impeller diameter D.

### PRIOR ART DOCUMENTS

### Patent Documents

Patent Document 1: JP2002-371997A

### SUMMARY OF INVENTION

### Problems to be Solved by the Invention

Vehicle seats for automobiles or the like that incorporate a centrifugal air blower have been proposed in recent years. In this application, there are demands for a seat incorporating a plurality of centrifugal air blowers and for increased passenger compartment space, and in order to respond to the demands, even smaller and lower profile impellers are required.

However, the configuration of Patent Document 1 has a problem in that when a lower profile impeller having an aspect ratio H/D of 0.2 or less is used, the air blowing performance per rotation of the impeller drops significantly.

In addition, there is another problem in that when the number of rotations of the impeller is increased in order to improve the air blowing performance, noise increases.

The present invention has been conceived to solve the above-described problems encountered in conventional technology, and it is an object of the present invention to provide a centrifugal air blower in which both improved air blowing performance and reduced noise are achieved. It is another object of the present invention to provide an automobile seat incorporating such a centrifugal air blower.

### Means for Solving Problem

A centrifugal air blower according to the present invention includes a centrifugal multi-blade impeller that has a plurality of blades around a central axis of rotation and that radially outwardly blows air taken in along the central axis of rotation and a spiral scroll casing housing the centrifugal multi-blade impeller. A ratio H/D of a height H of the centrifugal multi-blade impeller in a direction of the central axis of rotation to a diameter D of the centrifugal multi-blade impeller is 0.2 or less, and the scroll casing has a logarithmic spiral spread angle γ of 2.0 degrees or more.

An automobile seat according to the present invention incorporates the centrifugal air blower of the present invention.

### EFFECTS OF THE INVENTION

According to the present invention, because the logarithmic spiral spread angle γ of the casing is set properly, in the centrifugal air blower including the low profile impeller having a ratio H/D of 0.2 or less, the dynamic pressure generated by the impeller is converted to static pressure efficiently by the casing so that the air blowing performance (pressure-air flow characteristics) improves.

As a result of the improved air blowing performance, the number of rotations can be reduced, and consequently noise can be reduced.

Accordingly, with the centrifugal air blower of the present invention, it is possible to improve the air blowing capability per rotation and reduce air blowing noise.

### BRIEF DESCRIPTION OF DRAWINGS

FIG. 1 is a cross-sectional view of a centrifugal air blower according to an embodiment of the present invention.

FIG. 2A is a front view of a centrifugal multi-blade impeller constituting the centrifugal air blower shown in FIG. 1.

FIG. 2B is a top view of the centrifugal multi-blade impeller constituting the centrifugal air blower shown in FIG. 1.

FIG. 3 is a cross-sectional view of a scroll casing taken along the line IV-IV of FIG. 1.

FIG. 4 is a diagram showing nondimensional air blowing performance characteristics of two centrifugal air blowers having logarithmic spiral spread angles γ of the casing of 2.9 degrees and 1.0 degree, respectively.

FIG. 5 is a diagram showing the relationship between noise level and frequency of the centrifugal air blower having a logarithmic spiral spread angle γ of 2.9 degrees shown in FIG. 4.

FIG. 6 is a diagram showing the relationship between logarithmic spiral spread angle γ and air blowing performance.

FIG. 7 is a cut-out perspective view showing an embodiment of an automobile seat incorporating the centrifugal air blower of the present invention.

### MODES FOR CARRYING OUT THE INVENTION

A centrifugal air blower according to the present invention includes an impeller having a plurality of blades and a spiral casing housing the impeller. A driving source (for example, a motor) for rotating the impeller may be incorporated in the casing, or may be disposed outside the casing.

There is no particular limitation on the shape of the blades of the impeller, and the blades may be forward curved blades whose air outlet sections (outer ends) face the direction of rotation, or may be backward curved blades whose air outlet sections face a direction opposite to the direction of rotation. However, it is preferable to use forward curved blades whose outlet sections face the direction of rotation, and the blades preferably have an outlet angle β of 60° or more and 90° or less. This is because the energy that rotates the impeller can be converted to dynamic pressure efficiently.

There is also no particular limitation on the number of blades provided in the impeller.

It is preferable that an annular shroud is provided at an outer periphery on an air intake side of the impeller. With this configuration, due to a rectifying effect of the shroud, it is possible to suppress generation of a vortex resulting from air flow flowing radially outwardly from the impeller as well as backflow to the impeller, so that the blade passing frequency noise can be reduced.

Hereinafter, the present invention will be described in detail using a preferred embodiment. It is to be understood, however, that the present invention is not limited to the embodiment given below.

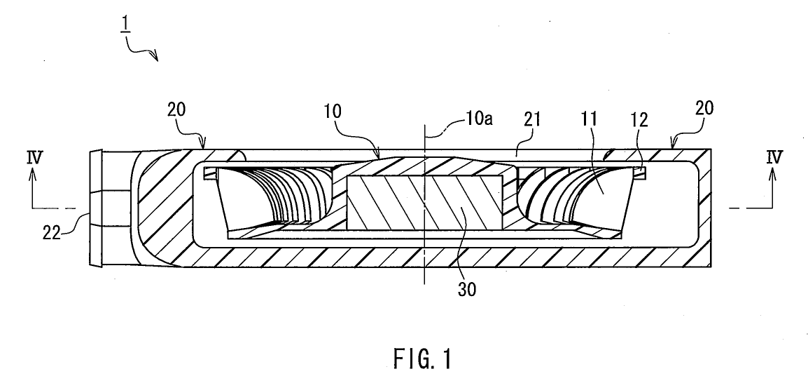

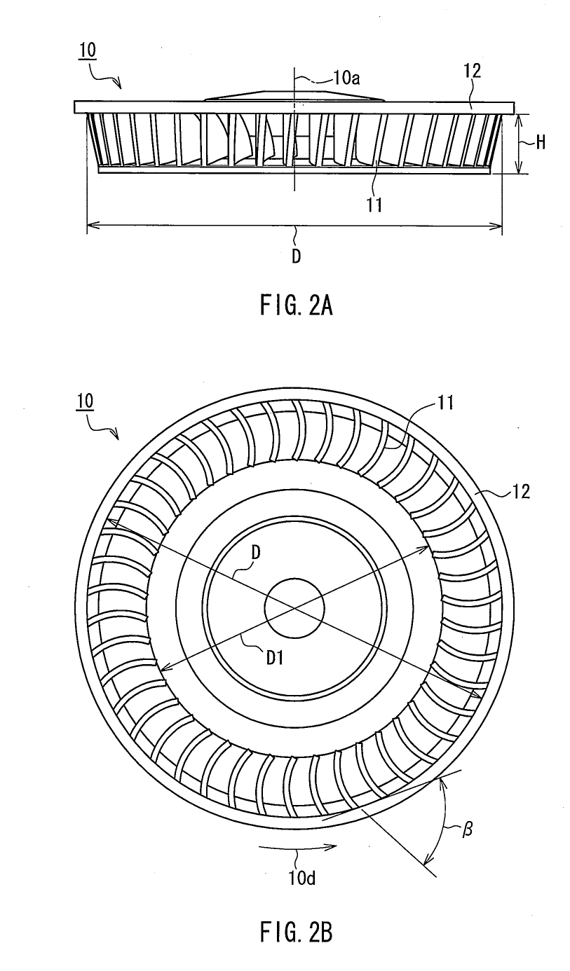

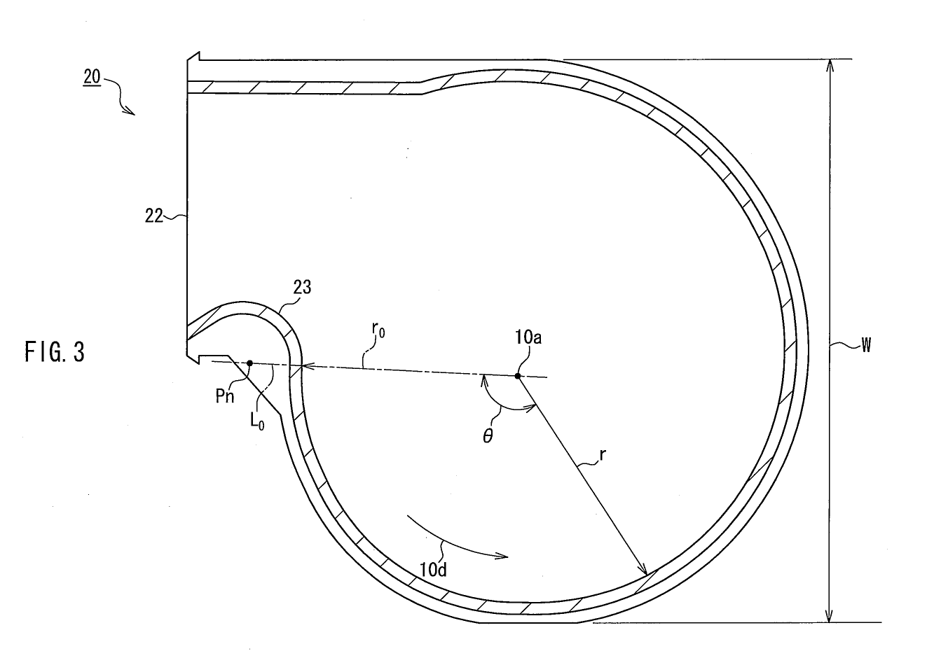

FIG. 1 is a cross-sectional view of a centrifugal air blower 1 according to an embodiment of the present invention. FIG. 2A is a front view of an impeller (centrifugal multi-blade impeller) 10, and FIG. 2B is a top view of the same. FIG. 3 is a cross-sectional view of a casing (scroll casing) 20 taken along the line IV-IV of FIG. 1.

The centrifugal air blower 1 includes the impeller 10 and the casing 20 housing the impeller 10.

The impeller 10 is rotationally driven about a central axis of rotation 10a in a direction of rotation 10d by an electric motor 30. The impeller 10 includes a number of blades (wings) 11 around the central axis of rotation 10a, and radially outwardly blows air taken in along the central axis of rotation 10a. A shroud 12 sequentially connecting outermost ends of the blades 11 is provided on an air inlet 21 side of the impeller 10 (see FIG. 1). The shroud 12 has an annular shape concentric with the impeller 10.

The casing 20 is a spiral scroll casing that collects air blown out of the impeller 10 and at the same time converts the dynamic pressure of the air to static pressure. The air inlet 21 is provided on one side in a direction of the central axis of rotation 10a of the air blower 1 (on the side opposite to the electric motor 30), and an air outlet 22 through which air is blown is provided at the spiral end side.

As shown in FIG. 2A, the impeller 10 is a low profile impeller whose ratio H/D (aspect ratio) of height H to diameter D is 0.2 or less, where the diameter of the impeller 10 (i.e., the diameter of an imaginary circle defined by the outer ends of the blades 11) is represented by D, and the height of the impeller 10 in a direction of the central axis of rotation 10a (i.e., the height of the blades 11 at the outlet section) is represented by H.

Where the diameter of an imaginary circle defined by inner ends of the blades 11 is represented by D1 (see FIG. 2B), a ratio D1/D is preferably 0.7 or less. If the ratio D1/D is greater than this value, the air blowing performance is degraded.

It is preferable that the outlet sections of the blades 11 of the impeller 10 face toward the same direction as the direction of rotation 10d of the impeller 10, and in particular, the blades 11 preferably have an outlet angle β of 60° or more and 90° or less. As used herein, the outlet angle β refers to, as shown in FIG. 2B, an angle between a tangent line extending along a blade 11 at the outer end of the blade 11 and a tangent line extending along the outer peripheral edge of the impeller 10 when the impeller 10 is viewed from the air inlet 21 side (see FIG. 1). The outlet angle β is measured from the forward side in the direction of rotation 10d of the impeller 10. If the outlet angle β falls within the above range of values, it is possible to increase the dynamic pressure of the air blown out of the impeller 10.

As shown in FIG. 3, an inner wall face of an outer shell of the casing 20 changes in a logarithmic spiral manner. A logarithmic spiral spread angle γ represented by the following equation is 2.0 degrees or more.

r=r₀·exp(θ·tan(γ)),

where r is a distance from the central axis of rotation 10a to the inner wall face of the outer shell of the casing 20,

r₀ is a distance from the central axis of rotation 10a to the inner wall face of the outer shell of the casing 20, extending along a reference line L₀ connecting a center of curvature Pn of a nose 23 and the central axis of rotation 10a, and

θ is an angle measured from the reference line L₀ connecting the center of curvature Pn of the nose 23 and the central axis of rotation 10a in the direction of rotation 10d of the impeller 10.

The technical significance of the logarithmic spiral spread angle γ being 2.0 degrees or more will be described.

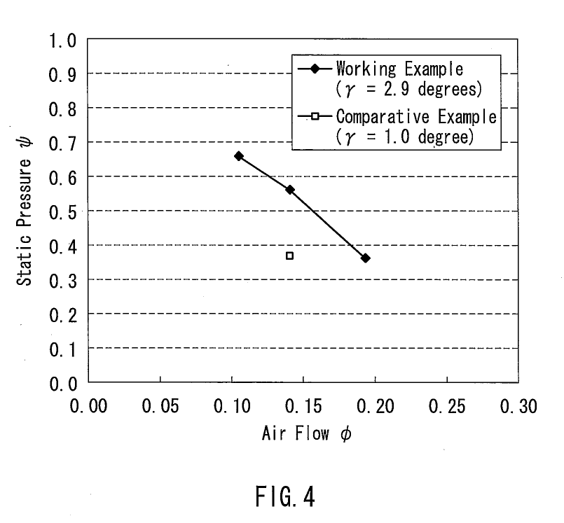

FIG. 4 is a diagram showing the air blowing performance of two centrifugal air blowers whose logarithmic spiral spread angles γ of the casing 20 are 2.9 degrees (working example) and 1.0 degree (comparative example). The two centrifugal air blowers had the same specifications, except that the logarithmic spiral spread angles γ were different. The aspect ratio H/D of the impeller 10 was 0.12. A maximum outer diameter W (see FIG. 3) in a direction perpendicular to the central axis of rotation 10a of a logarithmic spiral portion (the portion having the inner wall face of the outer shell that changes in a logarithmic spiral manner) of the casing 20 was 95 mm. In FIG. 4, the horizontal axis represents air flow φ, and the vertical axis represents static pressure ψ. The horizontal axis and the vertical axis are nondimensionalized.

Comparison of the working example in which the logarithmic spiral spread angle γ is 2.9 degrees and the comparative example in which the logarithmic spiral spread angle γ is 1.0 degree shows that the centrifugal air blower of the working example exhibits a higher static pressure than the centrifugal air blower of the comparative example at the same flow (φ)=0.14), indicating that the centrifugal air blower of the working example has higher air blowing performance.

Since the centrifugal air blowers of the working example and the comparative example are different only in terms of logarithmic spiral spread angle γ, the spacing (nose gap) between the nose 23 of the casing 20 and the impeller 10 is smaller in the centrifugal air blower of the working example. In centrifugal air blowers, generally, when the nose gap is reduced to improve the air blowing performance, noise (blade passing frequency noise, hereinafter referred to as “NZ noise”) that is generated by the air blown radially outwardly from the impeller impinging on the nose increases.

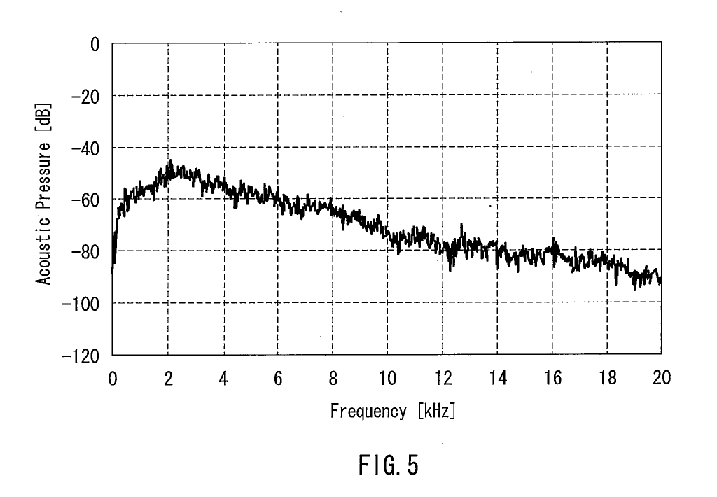

FIG. 5 is a diagram showing results of measurement of noise during operation of the centrifugal air blower of the working example shown in FIG. 4. The operation conditions were the same as those when φ=0.14 of FIG. 4. In FIG. 5, the horizontal axis represents frequency, and the vertical axis represents acoustic pressure. As can be seen from FIG. 5, no peak is observed at a specific frequency, indicating that harmful NZ noise did not occur.

As can be understood from the above description, according to the present invention, the range of the logarithmic spiral spread angle γ of the casing 20 (the lower limit value in particular) is set properly, and therefore in the centrifugal air blower using the low profile impeller having a small aspect ratio H/D, the dynamic pressure generated by the impeller 10 is converted to static pressure by the casing 20, so that the air blowing performance (pressure-air flow characteristics) improves. In addition, despite the fact that the air blowing performance improves, little harmful NZ noise will be generated.

Generally, in centrifugal air blowers, the air blowing performance improves as the number of rotations of the impeller is increased. The centrifugal air blower of the present invention has superior air blowing performance, and therefore the same level of static pressure as in conventional centrifugal air blowers can be obtained with a number of rotations of the impeller smaller than that of conventional centrifugal air blowers. According to the centrifugal air blower of the present invention, it is therefore possible to reduce the number of rotations of the impeller, and as a result, reduced noise can be achieved.

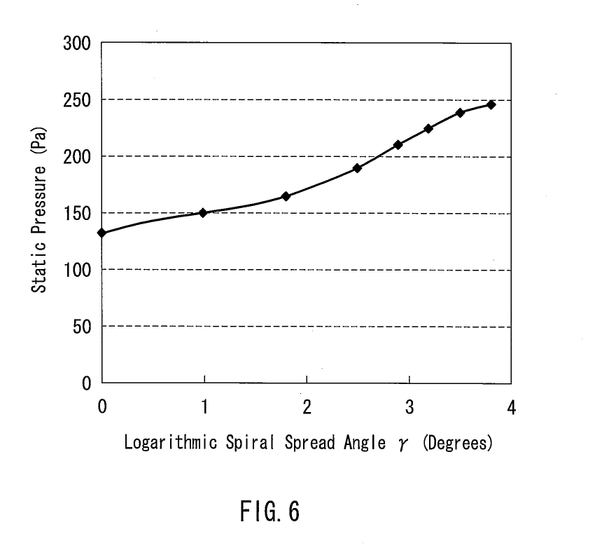

FIG. 6 is a diagram showing changes in air blowing performance when the logarithmic spiral spread angle γ is changed. The horizontal axis represents the logarithmic spiral spread angle γ, and the configuration of the centrifugal air blower is the same except for the logarithmic spiral spread angle γ. The vertical axis represents the static pressure of the centrifugal air blower. It can be seen that the larger the logarithmic spiral spread angle γ, the higher the static pressure that is obtained. Particularly when the logarithmic spiral spread angle γ is in a range from 2.0 degrees or more, the slope of the curve is large, from which it can be seen that increasing the logarithmic spiral spread angle γ is effective in improving the static pressure. Accordingly, in the present invention, the logarithmic spiral spread angle γ is set to 2.0 degrees or more.

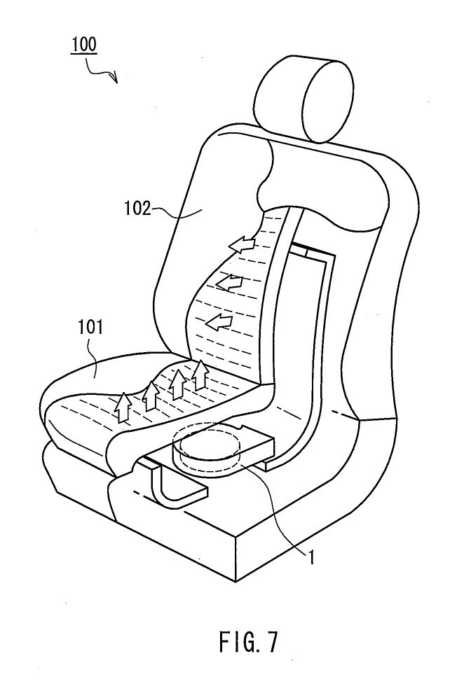

When the centrifugal air blower is incorporated in an automobile seat (see FIG. 7, which will be described later) and used as an air blower, the static pressure that the centrifugal air blower is required to have is 120 Pa or more, and preferably 190 Pa or more. Accordingly, from FIG. 6, the logarithmic spiral spread angle γ is preferably 2.5 degrees or more.

In the present invention, there is no particular limitation on the upper limit value of the logarithmic spiral spread angle γ. However, as described above, the larger the logarithmic spiral spread angle γ, the smaller the nose gap, and there is a possibility that NZ noise might become noticeable. For this reason, generally, it is preferable that the logarithmic spiral spread angle γ is 4.0 degrees or less.

FIG. 7 is a cut-out perspective view showing an embodiment of an automobile seat 100 incorporating the centrifugal air blower 1 of the present invention. The centrifugal air blower 1 is incorporated in a seating portion 101 of the seat 100. Air that has been generated by an air conditioner (not shown) disposed outside the seat 100 and whose temperature and humidity have been adjusted as appropriate is introduced into the air inlet of the centrifugal air blower 1 through a duct (not shown). The air blown from the outlet of the centrifugal air blower 1 is directed toward the passenger through the seating portion 101 and a seat back 102. In FIG. 7, the centrifugal air blower 1 is incorporated only in the seating portion 101, but it may also be incorporated in the seat back 102.

As described above, because the centrifugal air blower 1 of the present invention includes the low profile impeller 10 having an aspect ratio H/D of 0.2 or less, the centrifugal air blower 1 is thin. Accordingly, any increase in the thickness of the seating portion 101 and the seat back 102 due to incorporation of the centrifugal air blower 1 will be very small. It is therefore possible to avoid having the interior space of the vehicle become cramped. Also, the centrifugal air blower 1 of the present invention is low noise, so that the passenger will hear little unpleasant noise even when the centrifugal air blower 1 is incorporated in the seat 100.

When incorporating the centrifugal air blower 1 in a limited space such as the seat 100, it is desirable that the maximum outer diameter W (see FIG. 3) of the casing 20 described above is 100 mm or less from the viewpoint of efficient use of the space.

The automobile seat is merely one of the fields of application of the centrifugal air blower of the present invention, and the centrifugal air blower of the present invention can have applications other than for automobile seats.

### INDUSTRIAL APPLICABILITY

The centrifugal air blower of the present invention is small and low profile, and at the same time has high air blowing capability and is low noise, so that it can especially preferably be used as an air blower disposed in a limited space (for example, a passenger compartment).

### DESCRIPTION OF REFERENCE NUMERALS

1 Centrifugal Air Blower
10 Impeller (Centrifugal Multi-Blade Impeller)
10a Central Axis of Rotation of Impeller
10d Direction of Rotation of Impeller
11 Blade (Wing)
12 Shroud
20 Casing (Scroll Casing)
21 Air Inlet
22 Air Outlet
23 Nose
30 Electric Motor
100 Automobile Seat
101 Seating Portion
102 Seat Back

1. A centrifugal air blower comprising: a centrifugal multi-blade impeller that has a plurality of blades around a central axis of rotation and that radially outwardly blows air taken in along the central axis of rotation; and a spiral scroll casing housing the centrifugal multi-blade impeller,
wherein a ratio H/D of a height H of the centrifugal multi-blade impeller in a direction of the central axis of rotation to a diameter D of the centrifugal multi-blade impeller is 0.2 or less, and
the scroll casing has a logarithmic spiral spread angle γ of 2.0 degrees or more.

2. The centrifugal air blower according to claim 1,
wherein the scroll casing has a logarithmic spiral spread angle γ of 2.5 degrees or more.

3. The centrifugal air blower according to claim 1,
wherein the blades of the centrifugal multi-blade impeller have an outlet angle β of 60° or more and 90° or less.

4. The centrifugal air blower according to claim 1,
wherein an annular shroud is provided at an outer periphery on an air intake side of the centrifugal multi-blade impeller.

5. An automobile seat incorporating the centrifugal air blower according to claim 1.
